(19) United States
(12) Patent Application Publication
(10) Pub. No.: US 2019/0268238 A1
(43) Pub. Date: Aug. 29, 2019

(54) METHODS, SYSTEMS, AND COMPUTER-READABLE MEDIA FOR PROVIDING COMMUNITY-BASED INFORMATION NETWORKS

(71) Applicant: CARII, INC, Media, PA (US)

(72) Inventor: Wun Fie LOA, Pilesgrove, NJ (US)

(21) Appl. No.: 16/404,318

(22) Filed: May 6, 2019

Related U.S. Application Data
(63) Continuation-in-part of application No. 15/301,892, filed on Oct. 4, 2016.
(60) Provisional application No. 61/975,635, filed on Apr. 4, 2014.

(51) Int. Cl. H04L 12/24; H04L 29/08

(52) U.S. Cl. CPC H04L 41/12; G06Q 50/01; H04L 67/20; H04L 67/10

(57) ABSTRACT

Methods, systems, and computer-readable media for providing an information network service are described. Some embodiments provide a community information network based on virtual groups or communities. The community information network may use community profiles and affiliations configured to facilitate collaboration the communities and members thereof. In some embodiments, elements may be shared as representations of the actual element. In this manner, a user may delete the shared element and cause the deletions of the representations of the actual element used by other members or communities to access the shared element, such that the element is no longer accessible by other users or communities.

### CLAIM OF PRIORITY

This application claims priority to U.S. patent application Ser. No. 15/301,892, filed on Oct. 14, 2016, which is a National Stage filing under 35 U.S.C. § 371 of International Patent Application No. PCT/US2015/024549, filed on Apr. 6, 2015 and entitled “METHODS, SYSTEMS, AND COMPUTER-READABLE MEDIA FOR PROVIDING COMMUNITY-BASED INFORMATION NETWORKS,” which claims the benefit of U.S. Provisional Application No. 61/975,635 filed on Apr. 4, 2014, the contents of which are incorporated by reference in their entirety as if fully set forth herein.

### FIELD OF THE EMBODIMENTS

The field of the embodiments relate to community based information networks.

### BACKGROUND OF THE EMBODIMENTS

Network services may provide users with an application or web-based platform for connecting with other users, communicating information, and sharing files, such as digital pictures. Examples of such network services include social network services (or “social networks”), such as Facebook® and Linkedin®, content sharing services, such as Twitter® and Pinterest®, social enterprise systems, such as Jive®, Lithium®, or Get Satisfaction®. The use of network services has increased dramatically since their inception and they have been integrated into a large number of websites and web-based services, such as e-commerce, news and information, and real-time information platforms. Accordingly, users and businesses now rely heavily on network services, such as social networks, for communication and the sharing of information, which allows them to reach a wider range of the public more effectively and efficiently.

Conventional social networks operate at the individual user level. For example, a user creates a profile on a social network and makes connections with other users. In general, users may either communicate and/or share files with each connection individually or may simultaneously communicate and/or share files with all of their connections (e.g., by posting a message or sharing a file). Although most social networks provide for the formation of groups, such groups are generally loose connections of individual user profiles connected to a common social network profile. Accordingly, conventional social network groups are essentially another individual user profile that operates as a group in name only, without any valuable functionality to provide community-based interaction. As a result, operating and communicating as an actual group using conventional social networks is challenging and generally ineffective. Thus, it would be beneficial to provide network services with virtual groups or communities configured to support and facilitate community engagement and information sharing in a secure and efficient manner.

### SUMMARY OF THE EMBODIMENTS

The present invention and its embodiments relate to a system for managing an information network. The system may include a processor and a non-transitory computer-readable storage medium in operable communication with the processor. The computer-readable storage medium may contain programming instruction(s) that, when executed, cause the processor to receive a request to create an affiliation between a first community and a second community. The request may be initiated by a first member of the first community. Next, the affiliation between the first community and the second community may be created. The affiliation may outline rule(s) associated with sharing informational elements at the second community. Furthermore, an attempt by the first member of the first community to share a first informational element may next be detected. In response, a compliance of the first informational element with the rule(s) associated with the affiliation may be verified. Upon verifying that the first information element complies with the rule(s) associated with the affiliation, the first information element may be published at the second community.

A computer-implemented method for managing the information network (by a processor) may also be described. The method may include receiving a request to create an affiliation between a first community and a second community. The affiliation may be created between the first community and the second community. The affiliation may outline rule(s) associated with sharing informational element(s) at the second community. Next, an attempt by a first member of the first community to share a first informational element at the second community may be detected. The first member may be a non-member of the second community. Furthermore, the first informational element may be verified to comply with the rule(s) associated with the affiliation. In response to the verification, the first informational element may be published at the second community through the affiliation.

A non-transitory computer-readable storage medium having computer-readable program code configured for managing an information network is also described. The computer-readable program code includes computer-readable program code configured to receive a request to create an affiliation between a first community and a second community. Computer-readable program code may also be configured to create the affiliation between the first community and the second community. The affiliation may outline rule(s) associated with sharing informational element(s) at the second community. Computer-readable program code may also be configured to detect an attempt by a first member of the first community to share a first informational element at the second community, wherein the first member is a non-member of the second community. Computer-readable program code may further be configured to verify the attempt to share the first informational element meeting the one or rules associated with the affiliation. In addition, computer-readable program code may be configured to publish the first informational element at the second community through the affiliation.

These and other features, aspects and advantages of the present invention will become better understood with reference to the following drawings, description and claims.

### BRIEF DESCRIPTION OF THE DRAWINGS

FIG. 1 shows an illustrative community information network system, according to an embodiment of the invention.

FIG. 2 shows another illustrative community information network system, according to an embodiment of the invention.

FIG. 3 shows an illustrative information network, according to an embodiment of the invention.

FIG. 4 shows another illustrative information network, according to an embodiment of the invention.

FIG. 5 shows yet another illustrative information network, according to an embodiment of the invention.

FIG. 6 shows yet another illustrative information network, according to an embodiment of the invention.

FIG. 7 illustrates various embodiments of a computing device for implementing the various methods and processes described herein.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations may be made thereto.

The present disclosure generally relates to systems, methods, and non-transitory computer-readable media for providing an information network service. In particular, some embodiments provide an information network service based on groups or communities (the “community information network” or “community information network system”). For instance, the community information network may include functionality for creating group or community profiles and providing for affiliations between such community profiles (or “communities”). The community profiles and the affiliations therebetween may be configured to facilitate collaboration between community profiles through the community information network. In some embodiments, an affiliation generally involves the ability to connect members, communities, groups (for example, a community and one or more members thereof), subgroups, or any combination thereof. In some embodiments, the community information network may be configured as a social network, an information and/or content sharing network, an enterprise application, a social enterprise application, a customer engagement network, or a combination thereof.

In some embodiments, access to the community profiles and/or content (or “elements”) associated therewith may be controlled through public/private designations. In some embodiments, users may share elements with other users and/or communities. Elements may include information, messages, or assets associated with a community or member that may be shared, disseminated, or otherwise communicated therebetween. Non-limiting examples of elements may include digital photographs, videos, electronic files, news, hyperlinks, messages, or the like. In some embodiments, elements may be shared as representations of the actual element. In this manner, a user may delete the shared element and cause the deletions of the representations of the actual element used by other members or communities to access the shared element, such that the element is no longer accessible by other users or communities.

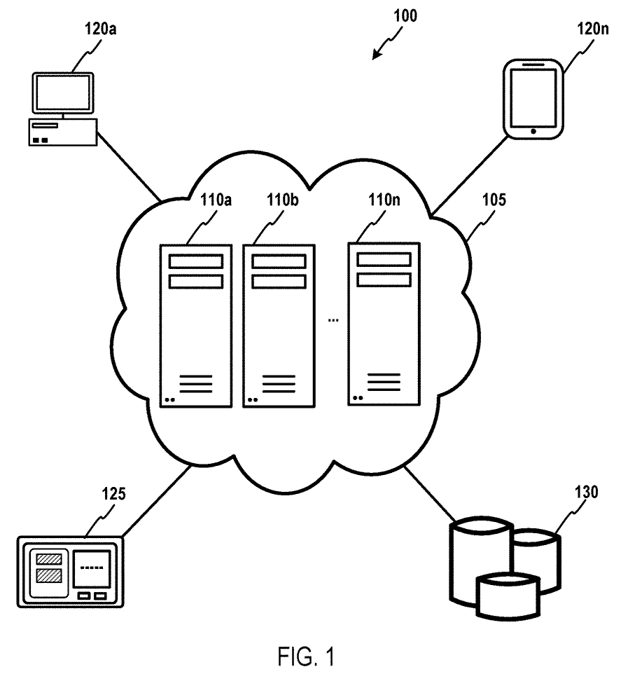

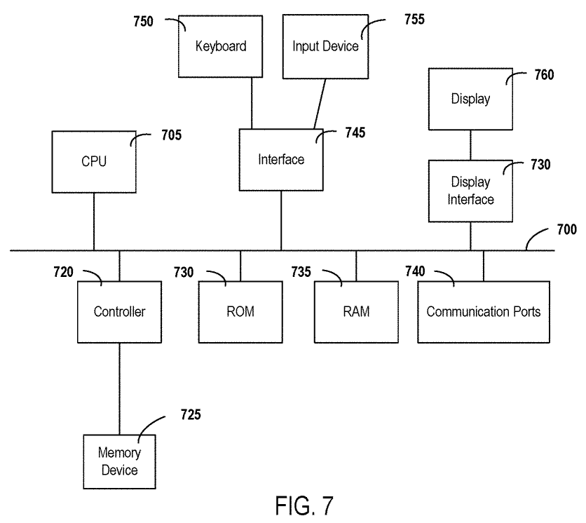

FIG. 1 depicts an illustrative community information network system according to a first embodiment. As shown in FIG. 1, the community information network system 100 may include one or more server logic devices 110a-n, which may generally include a processor, a non-transitory memory or other storage device for housing programming instructions, data or information regarding one or more applications, and other hardware, including, for example, the central processing unit (CPU) 705, read only memory (ROM) 730, random access memory (RAM) 735, communication ports 740, controller 720, and/or memory device 725 depicted in FIG. 7 and described below in reference thereto.

In some embodiments, the programming instructions may include a community information network application (the “information network application”) configured to, among other things, provide a community-based information network according to some embodiments. The server logic devices 110a-n may be in operable communication with client logic devices 120a-n through a network 105, such as the Internet. The client logic devices 120a-n may include, but are not limited to, server computing devices, personal computers (PCs), kiosk computing devices, mobile computing devices, laptop computers, smartphones, personal digital assistants (PDAs), tablet computing devices, or any other logic and/or computing devices now known or developed in the future.

In some embodiments, the information network application may be accessible through various platforms, such as a client application, web-based application, over the Internet, and/or a mobile application (for example, a “mobile app” or “app”). According to some embodiments, the information network application and/or components thereof may be configured to operate on each client logic device 120a-n and/or to operate on a server computing device accessible to logic devices over a network, such as the Internet. All or some of the files, data and/or processes for providing the community information network may be stored locally on each client logic device 120a-n and/or stored in a central location and accessible over a network.

In some embodiments, one or more data stores 115 may be accessible by the client logic devices 120a-120n and/or server logic devices 110a-n. The data stores 115 may include elements used by the information network application for presenting the community-based information network to users through the client logic devices 120a-n. Non-limiting examples of elements stored in the data stores 115 may include digital or electronic files, for instance, digital images, videos, files, messages, user profile information, community information, or the like. In some embodiments, at least a portion of the data stores 115 may include a third-party data source and/or elements from a third-party data source that may be accessed by the client logic devices 120a-n through the community information network.

In some embodiments, the information network application may be in operable communication with various third-party services 125, which may include websites, web-based service providers, and/or content providers. For example, users may be able to use the services of and/or access the data of various third-party web-based services through the information network application (for instance, through the community information network), including, without limitation, Twitter®, Instagram®, Reddit®, Facebook®, Linkedin®, Paypal®, Gmail, financial institutions, online libraries, applications, and search engines, or the like. In another example, users may be able to use the services of and/or access the data of various third-party content providers including, without limitation, broadcast television network websites, data repositories and/or data feeds (for instance, ESPN®, ABC News®, or the like), content streaming services (for instance, Netflix®, Hulu®, or the like), or the like. In this manner, through the data stores 115 and the third-party services 125, a community information network user or community may access and/or share third-party information, services, or functionality through the community information network.

Although the one or more data stores 115 are depicted as being separate from the logic devices 120a-n, 110a-n, embodiments are not so limited, as all or some of the one or more data stores may be stored in one or more of the logic devices.

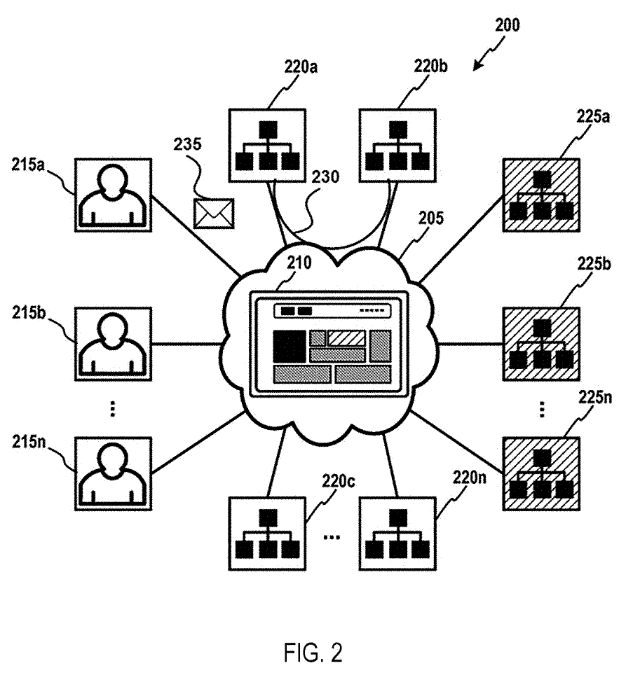

FIG. 2 depicts an illustrative community information network system according to a second embodiment. As shown in FIG. 2, a community information network system 200 may provide access to an information network interface (the “interface”) 210 representing an information network 205 of members 215a-n and communities 220a-n, 225a-n. The interface 210 may provide a graphical representation of the information network 205, its members 215a-n, communities 220a-n, 225a-n, available services, and/or relationships between any of these elements. The interface 210 may also provide users with access to services provided by the community information network system 200, including, without limitation, calendars, access to members 215a-n and communities 220a-n, 225a-n and information associated therewith, accesses to businesses affiliated with the community information network system 200, access to services provided by or affiliated with the community information network system, third-party websites, third-party services, or the like.

In general, users may join the information network and become members 215a-n by creating a user profile via the interface 210. The user profile for each member 215a-n may include various information about the user, including, without limitation, demographic information, personal interests, email information, and access information (for instance, username and password information). In some embodiments, the user profile may be based, at least partially, on a profile associated with a third-party website and/or service (for instance, a Facebook® or Gmail® account).

A member 215a-n may form a connection with other members through various methods. For instance, a member 215a may request a communication with another member 215b. Responsive to member 215b accepting the communication request from member 215a, member 215b and member 215a may be connected (for instance, become “friends,” “contacts,” “connections,” or the like) within the information network 205. In some embodiments, a member 215a-n may search for other members, for instance, through keyword searching and/or automated/semi-automated searching performed by the information network application based on member information, including email contacts, demographic information, common connections with other members, or the like.

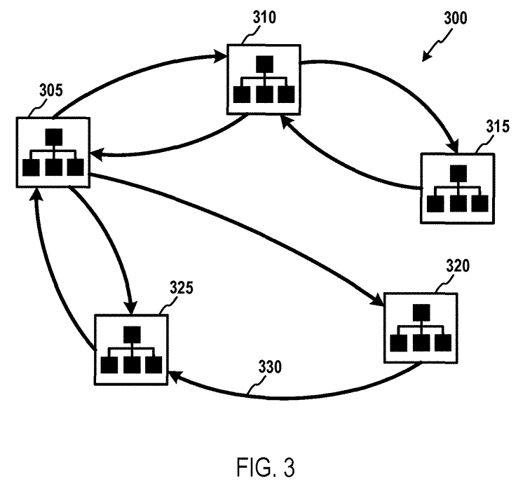

The information network 205 may include communities 220a-n, 225a-n. A member 215a-n may search for and/or join (or become an “affiliate” of) a community 220a-n, 225a-n in a manner the same or substantially similar to forming a connection with another member (a “member-community affiliation”). In addition, a community 220a-n, 225a-n may be an affiliate of another community (a “community affiliation”). Affiliates of a community 220a-n, 225a-n may have community rights within the community, such as access rights, sharing rights, administrative rights, or the like. For instance, access rights may specify affiliate access (for example, read, write, download, or the like) to community assets (for example, files, resources, affiliate information, messages, historical data) or the like. In another instance, sharing rights may specify access to shared elements and/or which affiliates may share elements within the community 220a-n, 225a-n or among accessible communities. In some embodiments, communication among communities and the sharing of elements associated therewith may be based at least partially on affiliations among communities (see FIG. 3, below). In some embodiments, the information network application may facilitate and/or designate affiliations through the creation of a dedicated record in a reference table or other information storage component that defines the relationships between members, communities, groups, subgroups, and any combination thereof.

As shown in FIG. 2, the information network 205 may include public communities 220a-n and private communities 225a-n. In some embodiments, public communities 220a-n may be publicly accessible to members 215a-n and other communities within the information network 205. For example, a member 215a-n and/or community 220a-n, 225a-n may access a public community 220a-n and shared elements thereof (for example, photographs, messages, affiliates, or the like). In some embodiments, only affiliates of a public community 220a-n may modify the public community (for example, post messages, share and/or delete elements, or the like). In some embodiments, all members 215a-n and/or communities 220a-n, 225a-n may modify a public community 220a-n. Although a public community 220a-n is designated as being publicly accessible, certain elements, functionality, and/or affiliates thereof may be designated as private.

The information network 205 may include private communities 225a-n. In general, a private community 225a-n and any elements and/or affiliates associated therewith may not be publicly accessible. In some embodiments, one or more aspects, elements, and/or affiliates of a private community 225a-n may be made accessible to the public or specified non-affiliates, for example, through various security and/or access parameters or settings. For instance, a private community 225a-n may be visible to members 215a-n while the elements of the private group and/or the affiliates thereof may not be accessible or may be visible, but not accessible.

In some embodiments, the community information network system 200 may monitor and/or record member 215a-n and/or community 225a-n activity within the information network system. In some embodiments, the community information network system 200 may reward or otherwise compensate activity by members 215a-n and/or communities 225a-n within the community information network system 200 based on the member 215a-n and/or community 225a-n activity. For example, the community information network system 200 may share revenue with members 215a-n and/or communities 225a-n based on engagement and/or specified actions within the community information network system 200 and components thereof, including, without limitation, forming affiliations, recruiting members 215a-n and/or communities 225a-n, sharing content, communicating with members 215a-n and/or communities 225a-n, and/or generating revenue for the community information network system 200. The compensation may be in various forms, including financial, redeemable points, increased access, increased resources, increased membership capacity, access to and/or increased access to services or businesses, or the like. In some embodiments, the compensation may include a bonus or a certain percentage of revenue generated through the site associated with the member 215a-n and/or community 225a-n activity. In some embodiments, the compensation may include charitable donations. For example, the community information network system 200 may regionally pool or reserve a certain percentage of revenue, and members 215a-n and/or communities 225a-n may apply for grants for local efforts or activities.

FIG. 3 depicts an illustrative information network according to a first embodiment. As shown in FIG. 3, an information network 300 may include a set of communities 305-325. Each of the communities 305-325 may be connected to or affiliated with one or more of the other communities through an affiliation 330. Although multiple affiliations 330 are depicted in FIG. 3, only one is labeled to simplify the figure. The affiliations 330 specify whether a community 305-325 may communicate with another community, such as by accessing elements of another community and/or sending/receiving elements to/from a second community. In some embodiments, communication or the dissemination of information and/or assets by communities 305-325 may include, without limitation, communication internally within a community to all and/or selected members thereof, communication to all and/or selected members of all affiliated communities, or to selected affiliated communities.

Affiliations 330 between communities 305-325 may be configured as being reciprocal (for instance, inclusive) or non-reciprocal (for instance, exclusive). For example, community 305 has an affiliation with community 325 such that community 305 may communicate with community 325. In addition, community 325 also has an affiliation with community 305 such that community 325 may communicate with community 305. As such, community 305 and community 325 have reciprocal affiliations (for example, an inclusive affiliation). In another example, community 305 has an affiliation with community 320 such that community 305 may communicate with community 320. However, community 320 does not have an affiliation with community 305 and, as such, community 320 cannot communicate or communicate directly with community 305 (i.e., a non-reciprocal affiliation or an exclusive affiliation). In some embodiments, a community 305-325 may communicate with non-affiliated communities through a communication path that includes affiliated communities. For instance, community 320 has an affiliation with community 325, which has reciprocal affiliations with community 305. As such, community 320 may communicate with community 325 and community 325 may communicate with community 305. In this manner, community 320 may disseminate information and/or share assets with community 305 via community 325.

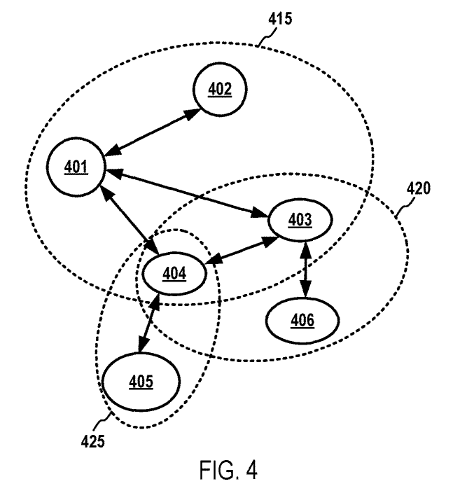

FIG. 4 depicts an illustrative information network according to a second embodiment. As shown in FIG. 4, community 401 has an affiliation 415 with communities 402-404 such that members of community 401 may communicate with all members of communities 402-404, and members of communities 402-404 may only communicate with all members of community 401. Community 403 has an affiliation 420 with communities 404 and 406. Members of community 403 may communicate with all members of communities 404 and 406, and members of communities 404 and 406 can only communicate with all members of community 403. Community 404 is affiliated with community 405. Members of community 404 can communicate with all members of community 405, and members of community 405 can communicate with all members of community 404. Members of community 402 cannot communicate with members of communities 403 and 404 and vice versa. Members of community 404 cannot communicate with members of community 406 and vice versa.

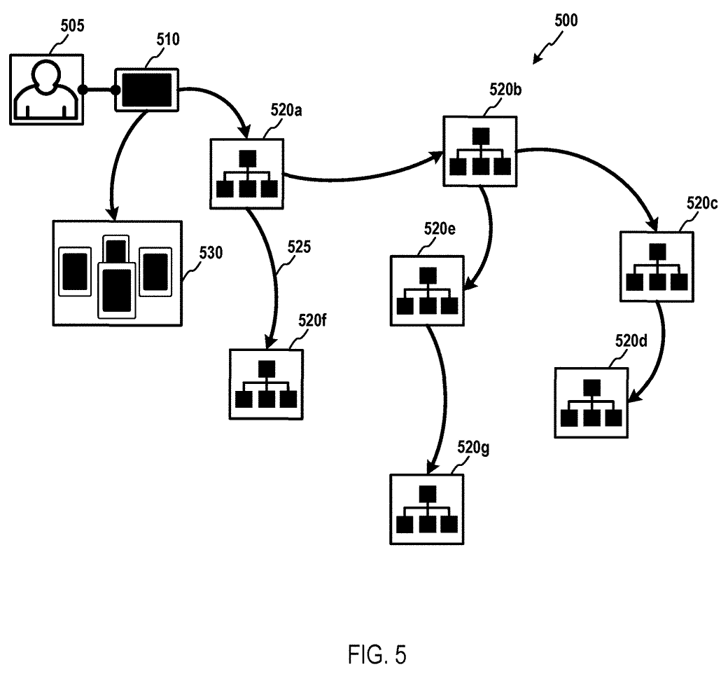

FIG. 5 depicts an illustrative information network according to some embodiments. As shown in FIG. 5, an information network 500 may include communities 520a-g associated through affiliations 525. A member 505 may upload an element 510 for sharing with community 520a. For example, the information network application may present the member 505 with a display object module interface for selecting, uploading, or otherwise processing an element 510. In some embodiments, the member 505 may select to display or “post” and/or share the element 510. Whether the element 510 may be posted or shared within the information network 500 and/or which communities 520a-g may interact with the element may be determined based on element settings for the community and/or member. For instance, whether members 505 of the community 520a-g are able to post and/or share elements 510.

In some embodiments, shared elements 510 may be accessed and/or viewed using various display configurations. An illustrative and non-restrictive display configuration is a carousel configuration 530 which allows for carousel-like (or wrap-around) scrolling through multiple elements 510, such as digital photos, videos, files, postings, or the like. In some embodiments, a member 505 may post a plurality of elements 510 in a single posting or a succession of postings that may be accessible from a single display configuration, such as a carousel configuration 530. For example, a member 505 may be interested in posting information about an event. The member 505 may post elements 510, such as a news article, textual messages, videos, word documents, digital maps, or the like, in a carousel configuration 530. In this manner, other members 505 may access all of the posted information for the invention through the single presentation interface of the carousel configuration 530. In some embodiments, the carousel configuration may be an element 510 that may be shared within the social network 500 or externally similar to the sharing of an individual element.

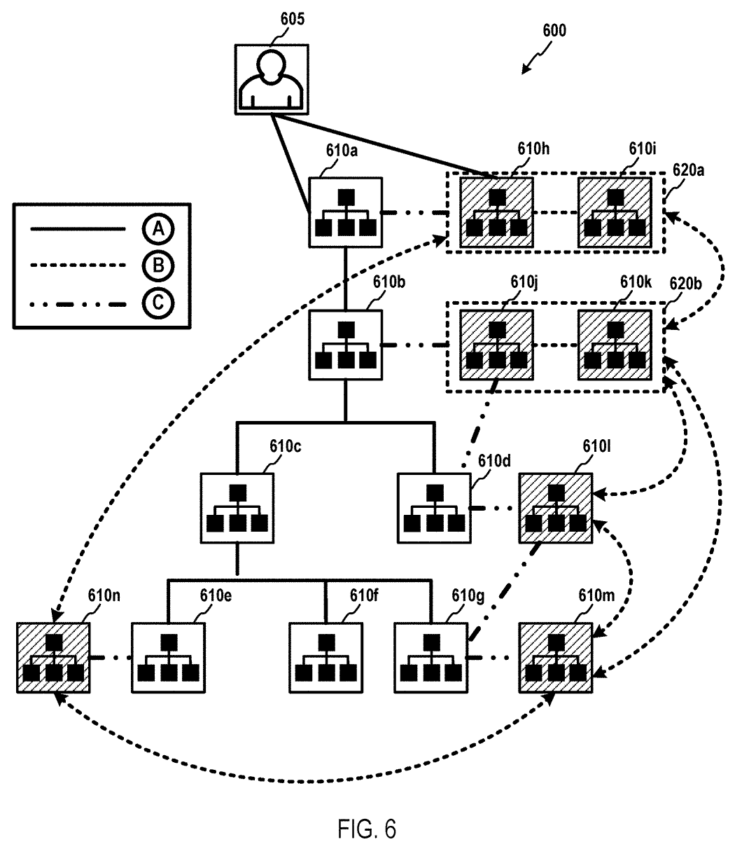

FIG. 6 depicts an illustrative information network according to some embodiments. As shown in FIG. 6, an information network 600 may include members 605 and communities 610a-n. The members 605 may be associated with one or more communities 610a-n. The communities 610a-n may include public communities 610a-g and private communities 610h-n. Public communities 610a-g may be cross-connected through public-public affiliations A. The private communities 610h-n may be formed into private groups 620a, 620b. The private communities 610h-n and/or private groups 620a, 620b may be cross-connected through private-private affiliations B. The public communities 610a-g and the private communities 610h-n and/or private groups 620a, 620b may be cross-connected through public-private affiliations C. In this manner, communities 620a-n may be cross-connected through the various affiliations A, B, C and communication may be established therebetween through any path (an “affiliation path”) formed through the affiliations. For example, public community 610a may be cross-connected with private community 610m through the affiliations between community 610a, group 620a, group 620b, and community 610m, and vice versa. In this manner, the information network 600 configured according to some embodiments may facilitate communication and collaboration among members 605 and communities 610a-n, while maintaining the requisite privacy and security of the information network members and communities.

FIG. 7 depicts a block diagram of exemplary internal hardware that may be used to contain or implement the various computer processes and systems as discussed above. A bus 700 serves as the main information highway interconnecting the other illustrated components of the hardware. CPU 705 is the central processing unit of the system, performing calculations and logic operations required to execute a program. CPU 705, alone or in conjunction with one or more of the other elements disclosed in FIG. 7, is an exemplary processing device, computing device or processor as such terms are used within this disclosure. Read only memory (ROM) 730 and random access memory (RAM) 735 constitute exemplary memory devices.

A controller 720 interfaces with one or more optional memory devices 725 to the system bus 700. These memory devices 725 may include, for example, an external or internal DVD drive, a CD ROM drive, a hard drive, flash memory, a USB drive or the like. As indicated previously, these various drives and controllers are optional devices. Additionally, the memory devices 725 may be configured to include individual files for storing any software modules or instructions, auxiliary data, common files for storing groups of results or auxiliary, or one or more databases for storing the result information, auxiliary data, and related information as discussed above.

Program instructions, software or interactive modules for performing any of the functional steps associated with various embodiments described above may be stored in the ROM 730 and/or the RAM 735. Optionally, the program instructions may be stored on a tangible (non-transitory) computer-readable medium such as a compact disk, a digital disk, flash memory, a memory card, a USB drive, an optical disc storage medium, such as a Blu-ray™ disc, and/or other recording medium.

An optional display interface 730 may permit information from the bus 700 to be displayed on the display 760 in audio, visual, graphic or alphanumeric format. The information may include information related to a current job ticket and associated tasks. Communication with external devices may occur using various communication ports 740. An exemplary communication port 740 may be attached to a communications network, such as the Internet or a local area network.

The hardware may also include an interface 745 which allows for receipt of data from input devices such as a keyboard 750 or other input device 755 such as a mouse, a joystick, a touch screen, a remote control, a pointing device, a video input device and/or an audio input device.

In another example of an embodiment may include a system 200 for managing an information network 205. The system 200 may include a processor 705 and a non-transitory computer-readable storage medium in operable communication with the processor 705. The computer-readable storage medium may contain programming instruction(s) that, when executed, cause the processor to receive a request to create an affiliation 230 between a first community 220a and a second community 220b. The request may be initiated by a first member 215a of the first community 220a.

Next, the affiliation 230 between the first community 220a and the second community 220b may be created. The affiliation may outline rule(s) associated with sharing informational elements at the second community 220b. The rule(s) may restrict content to be shared within the information element(s).

An attempt by the first member 215a of the first community 220a to share a first informational element 235 may next be detected. In response, a compliance of the first informational element 235 with the rule(s) associated with the affiliation 230 may be verified. Upon verifying that the first information element complies with the rule(s) associated with the affiliation 230, the first information element may be published at the second community 220b.

The rule(s) associated with the affiliation 230 may describe an access privilege granted at the second to a non-member. The first member 215a of the first community 220a may be the non-member of the second community 220b. Furthermore, the first information element 235 may include a communication from the first member 215a.

The information network 205 may include a social network, a content sharing network, or a social enterprise network. Furthermore, the affiliation 230 may include a reciprocal affiliation or non-reciprocal affiliation. The reciprocal affiliation may establish rule(s) for sharing of informational element(s) between the first community 220(a) and the second community 220(b) in either direction. The non-reciprocal affiliation may establish rule(s) for sharing of informational element(s) from the first community 220(a) to the second community 220(b) (or in a reverse direction).

The first or second communities (220a or 220b) may include a public or a private community. Furthermore, a reward may be provided to the first member 215a based on the published first informational element 235. The published first informational element may be associated with a formation of the affiliation, a recruitment of a member of the second community 220b, a recruitment of the second community 220b, a sharing of a content (such as the first informational element 235), a communication with a member of the second community 220b, or a revenue creation associated with the information network 205. The reward may include a financial compensation, a redeemable point, an elevated access to the second community, an increased resource, an increased membership capacity associated with the first community, an increased access to a service, a percentage of a revenue of the information network, and a charitable donation.

In another example scenario, comment(s) associated with a post or information share across community are consolidated into a comment stream across communities that it has been shared with. For example, a post or an article may be an object that all communities point to once the post or article may have been shared via membership or affiliation. As such, cross community corroboration may be enabled.

A computer-implemented method for managing the information network 205 (by the processor 705) may also be described. The method may include receiving a request to create an affiliation between a first community and a second community. The affiliation may be created between the first community and the second community. The affiliation may outline rule(s) associated with sharing informational element(s) at the second community. Next, an attempt by a first member of the first community to share a first informational element at the second community may be detected. The first member may be a non-member of the second community. Furthermore, the first informational element may be verified to comply with the rule(s) associated with the affiliation. In response to the verification, the first informational element may be published at the second community through the affiliation.

In another example scenario, a portion of a local revenue of the second community may be reserved. Next, a grant request for the published first informational element may be received from the second community. The portion of the local revenue of the second community associated with the grant request may be granted (or provided) to the first member of the first community.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A system for managing an information network, the system comprising:
a processor; and
a non-transitory computer-readable storage medium in operable communication with the processor, wherein the computer-readable storage medium contains one or more programming instructions that, when executed, cause the processor to:
receive a request to create an affiliation between a first community and a second community;
create the affiliation between the first community and the second community, wherein the affiliation outlines one or more rules associated with sharing one or more informational elements at the second community;
detect an attempt by a first member of the first community to share a first informational element at the second community;
verify a compliance of the first informational element with the one or rules associated with the affiliation; and
publish the first informational element at the second community through the affiliation.

2. The system of claim 1, wherein the one or more rules associated with the affiliation describe an access privilege at the second community for a non-member.

3. The system of claim 2, wherein the first member of the first community is the non-member of the second community.

4. The system of claim 1, wherein the first informational element includes a communication from the first member.

5. The system of claim 1, wherein the information network includes a social network, a content sharing network, or a social enterprise network.

6. The system of claim 1, wherein the affiliation includes a reciprocal affiliation or a non-reciprocal affiliation.

7. The system of claim 1, wherein the first or second community includes a public or a private community.

8. The system of claim 1, wherein the computer-readable storage medium further contains one or more programming instructions that, when executed, cause the processor to:
provide a reward to the first member based on the published first informational element.

9. The system of claim 8, wherein the published first informational element is associated with a formation of the affiliation, a recruitment of a member of the second community, a recruitment of the second community, a sharing of a content, a communication with a member of the second community, or a revenue creation associated with the information network.

10. The system of claim 8, wherein the reward includes a financial compensation, a redeemable point, an elevated access to the second community, an increased resource, an increased membership capacity associated with the first community, an increased access to a service, a percentage of a revenue of the information network, and a charitable donation.

11. A computer-implemented method for managing an information network, the method comprising, by a processor:
receiving a request to create an affiliation between a first community and a second community;
creating the affiliation between the first community and the second community, wherein the affiliation outlines one or more rules associated with sharing one or more informational elements at the second community;
detecting an attempt by a first member of the first community to share a first informational element at the second community, wherein the first member is a non-member of the second community;
verifying a compliance of the first informational element with the one or more rules associated with the affiliation; and
publishing the first informational element at the second community through the affiliation.

12. The method of claim 11, wherein further comprising:
reserving a portion of a local revenue of the second community;
receiving a grant request for the published first informational element from the second community; and
granting the portion of the local revenue of the second community associated with the grant request to the first member of the first community.

13. The method of claim 11, further comprising:
transmitting the published first informational element to an external platform.

14. A non-transitory computer-readable storage medium having computer-readable program code configured for managing an information network, the computer-readable program code comprising:
computer-readable program code configured to receive a request to create an affiliation between a first community and a second community;
computer-readable program code configured to create the affiliation between the first community and the second community, wherein the affiliation outlines one or more rules associated with sharing one or more informational elements at the second community;
computer-readable program code configured to detect an attempt by a first member of the first community to share a first informational element at the second community, wherein the first member is a non-member of the second community;
computer-readable program code configured to verify the attempt to share the first informational element meeting the one or rules associated with the affiliation; and
computer-readable program code configured to publish the first informational element at the second community through the affiliation.
